(19) United States
(12) Patent Application Publication
(10) Pub. No.: US 2025/0317968 A1
(43) Pub. Date: Oct. 9, 2025

(54) TRUST MECHANISM FOR PEER STA OPERATION

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Plano, TX (US); Bilal Sadiq, Plano, TX (US)

(21) Appl. No.: 19/087,328

(22) Filed: Mar. 21, 2025

Related U.S. Application Data
(60) Provisional application No. 63/631,150, filed on Apr. 8, 2024.

(51) Int. Cl. H04W 74/0816; H04L 5/00; H04W 12/06; H04W 74/04

(52) U.S. Cl. CPC H04W 74/0816; H04L 5/0053; H04W 12/06; H04W 74/04

(57) ABSTRACT

A method and device for a trust mechanism for peer STA operation. A method performed by a first STA associated with an AP comprises initiating a protocol between the first STA, a second STA, and the AP. The protocol is associated with coexistence constraints for the first STA and coexistence constraints for the second STA. The method further comprises indicating, to the AP, about the coexistence constraints for the first STA, and indicating, to the AP, about the coexistence constraints for the second STA on behalf of the second STA.

### CROSS-REFERENCE TO RELATED APPLICATION(S) AND CLAIM OF PRIORITY

This application claims priority under 35 U.S.C. § 119(e) to U.S. Provisional Patent Application No. 63/631,150, filed on Apr. 8, 2024, which is hereby incorporated by reference in its entirety.

### TECHNICAL FIELD

This disclosure relates generally to wireless communication, and more specifically to a trust mechanism for peer station (STA) operation.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for trust mechanism for peer STA operation.

In one embodiment, a method of wireless communication performed by a first STA associated with an access point (AP) comprises: initiating a protocol between the first STA, a second STA, and the AP, the protocol associated with coexistence constraints for the first STA and coexistence constraints for the second STA; indicating, to the AP, about the coexistence constraints for the first STA; and indicating, to the AP, about the coexistence constraints for the second STA on behalf of the second STA.

In another embodiment, an AP comprises: a processor; and a transceiver operably coupled with the processor. The transceiver is configured to: receive from a first STA associated with the AP, information associated with initiating a protocol between the first STA, a second STA, and the AP, the protocol associated with coexistence constraints for the first STA and coexistence constraints for the second STA; receive an indication from the first STA about the coexistence constraints for the first STA; receive an indication from the first STA about the coexistence constraints for the second STA on behalf of the second STA; and transmit, to the first STA, signals associated with the protocol.

In yet another embodiment, a first STA comprises: a transceiver; and a processor operably coupled with the transceiver. The processor is configured to: initiate a protocol between the first STA, a second STA, and an AP associated with the first STA, the protocol associated with coexistence constraints for the first STA and coexistence constraints for the second STA; generate an indication about the coexistence constraints for the first STA; and generate an indication about the coexistence constraints for the second STA on behalf of the second STA.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of a network where infrastructure traffic and non-infrastructure traffic coexist according to embodiments of the present disclosure;

FIG. 5 illustrates an example for the need for trust between peer STAs and an access point (AP) for the purpose of a proxy coexistence indication according to embodiments of the present disclosure;

FIG. 6 illustrates an example of a call flow for ensuring trust between peer STAs according to embodiments of the present disclosure;

FIG. 7 illustrates an example of another call flow for ensuring trust between peer STAs according to embodiments of the present disclosure;

FIG. 8 illustrates an example of yet another call flow for ensuring trust between peer STAs according to embodiments of the present disclosure; and

FIG. 9 illustrates an example method for a trust mechanism for peer STA operation according to embodiments of the present disclosure.

### DETAILED DESCRIPTION

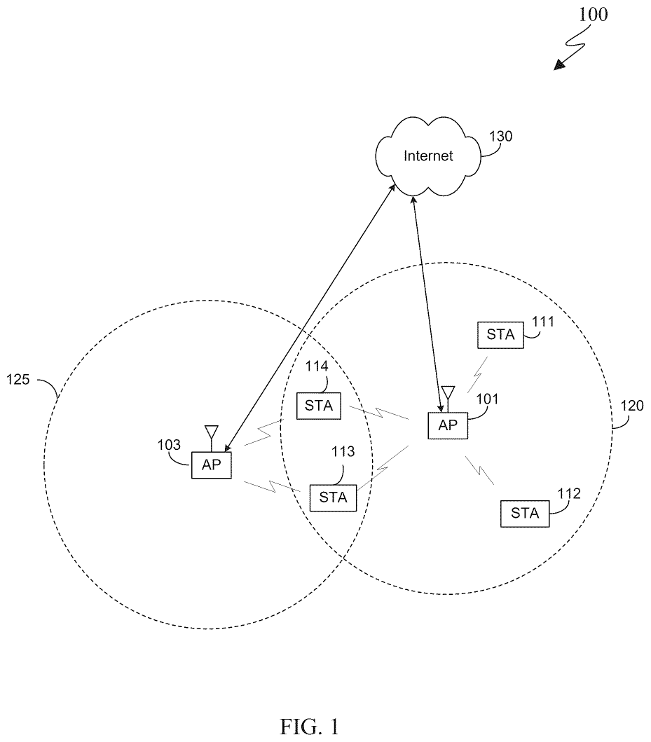

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment,” “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating a trust mechanism for peer STA operation. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

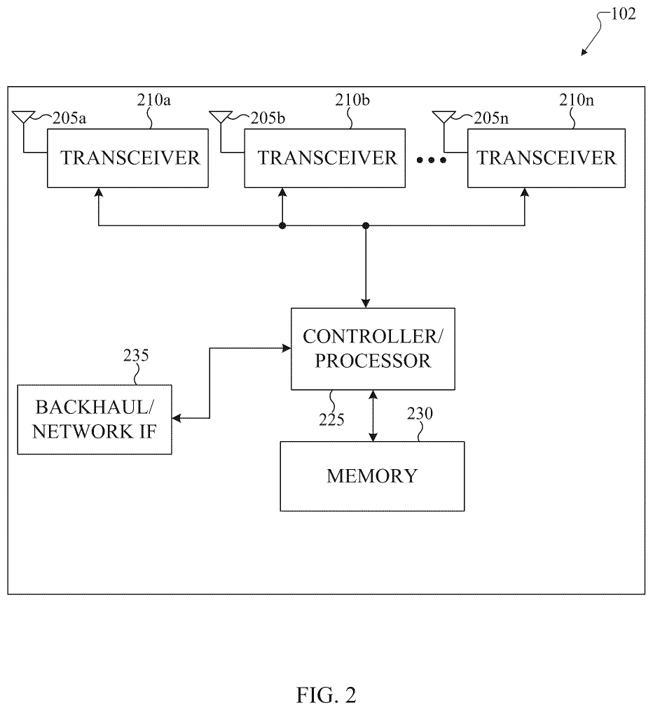

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating a trust mechanism for peer STA operation. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating a trust mechanism for peer STA operation. Although FIG. 2 illustrates one example of AP 101, various changes may be made to FIG. 2. For example, the AP 101 could include any number of each component shown in FIG. 2. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

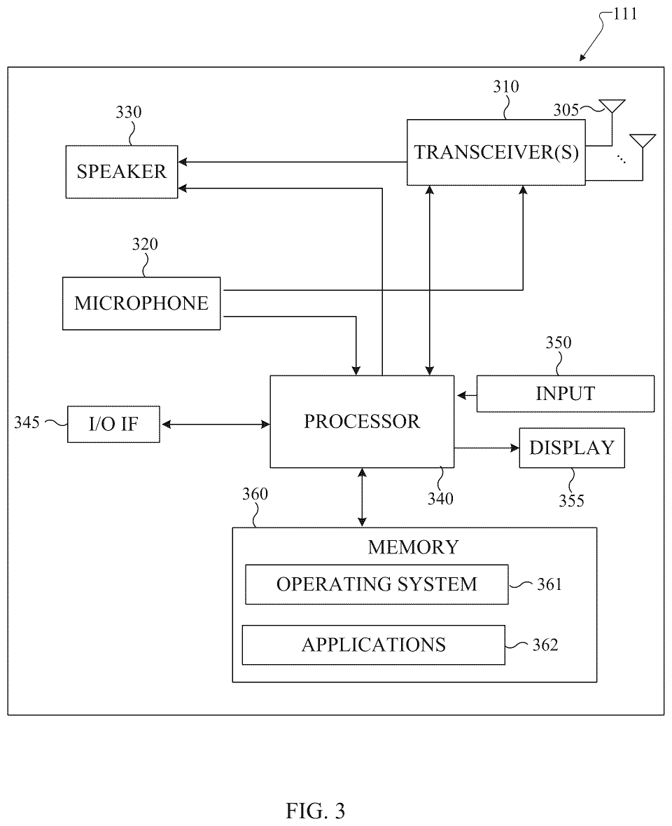

FIG. 3 illustrates an example STA 111 according to various embodiments of the present disclosure. The embodiment of the STA 111 illustrated in FIG. 3 is for illustration only, and the STAs 111-115 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate a trust mechanism for peer STA operation. In some embodiments, the processor 340 includes at least one microprocessor or microcontroller.

The processor 340 is also capable of executing other processes and programs resident in the memory 360, such as operations for facilitating a trust mechanism for peer STA operation. The processor 340 can move data into or out of the memory 360 as required by an executing process. In some embodiments, the processor 340 is configured to execute a plurality of applications 362, such as applications for facilitating a trust mechanism for peer STA operation. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that a next generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the access point (AP) as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

Embodiments of the present disclosure recognize that in-device coexistence (coex) is an issue that the IEEE 802.11bn is considering addressing. A first STA can inform the associated AP about the first STA's possible coex events so that the AP can be aware of the first STA's coex constraints. For example, if the AP is made aware of such possible coex situation of the first STA, then the AP may avoid transmitting frames to the first STA during the coex event. Also, upon transmitting frames to the first STA, if the AP does not receive any corresponding Ack frames from the first STA, then the AP may not take any punitive action against STA1 such as reducing rate or reducing MCS for the first STA.

Embodiments of the present disclosure also recognize that when the first STA has coex events, it often involves a second STA with which the first STA has the coex event. Many of the constraints that are applicable to the coex events for the first STA may also be applicable to the coex events for the second STA. While the first STA can inform the associated AP about its own upcoming coex event and corresponding constraints, the first STA may also identify the second STA as the coex peer STA corresponding to the coex event. In this way, the AP can be aware of the second STA's coex event constraints along with the first STA coex event constraints. However, currently there is no mechanism to establish mutual trust between the peer STA to allow the first STA to indicate the coex event for the second STA.

Accordingly, various embodiments of the present disclosure can provide methods and apparatuses for a trust mechanism for peer STA operation so that a first STA is able to indicate to an associated AP about coex event constraints for a second STA.

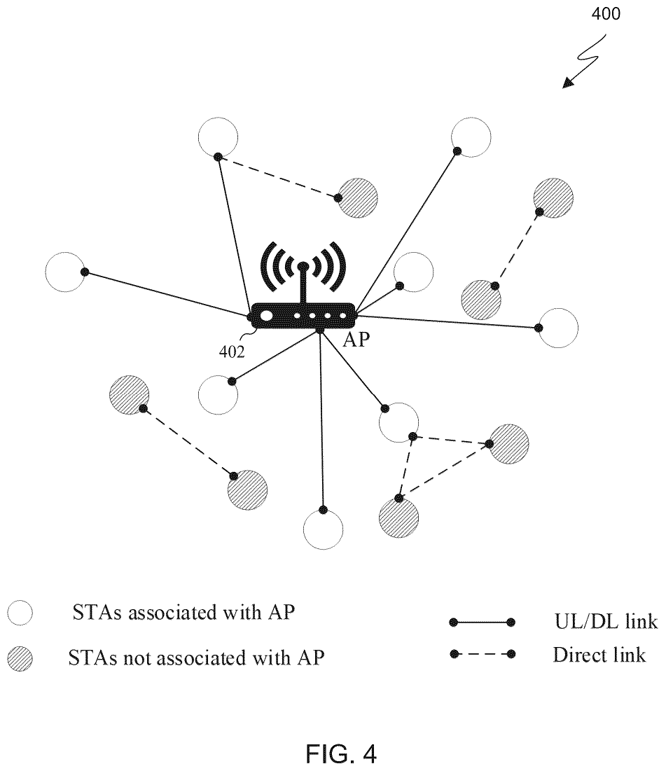

FIG. 4 illustrates an example of a network 400 where infrastructure traffic and non-infrastructure traffic coexist according to embodiments of the present disclosure. The embodiment of the example network 400 where infrastructure traffic and non-infrastructure traffic coexist shown in FIG. 4 is for illustration only. Other embodiments of the example network 400 where infrastructure traffic and non-infrastructure traffic coexist could be used without departing from the scope of this disclosure.

As illustrated in FIG. 4, the AP 402 as the network controller may not have enough control over the unregulated/unmanaged traffic that contend with the low-latency traffic within the infrastructure BSS. Some of the unmanaged traffic that interfere with the AP's BSS' latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. FIG. 4 illustrates this kind of network.

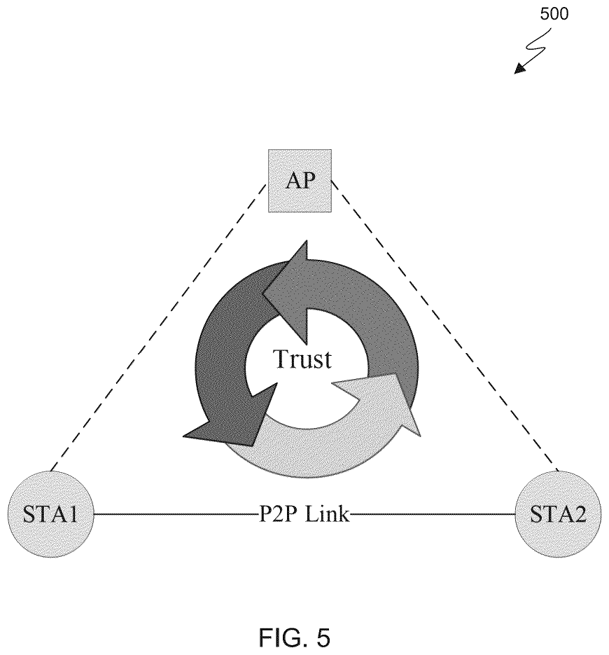

FIG. 5 illustrates an example 500 for the need for trust between peer STAs and an access point (AP) for the purpose of a proxy coexistence indication according to embodiments of the present disclosure. The embodiment of the example 500 for the need for trust between peer STAs and an access point (AP) for the purpose of a proxy coexistence indication shown in FIG. 5 is for illustration only. Other embodiments of the example 500 for the need for trust between peer STAs and an access point (AP) for the purpose of a proxy coexistence indication could be used without departing from the scope of this disclosure.

According to some embodiments, in order for a first STA to be able to indicate to the associated AP about coex event constraints for a second STA, the first STA may set up a trust protocol among the first STA, the second STA, and the AP. This is illustrated in FIG. 5.

According to some embodiments, the first STA may set up the trust protocol before the first STA indicates to the associated AP about the coex constraints of the second STA. According to another embodiment, the first STA may set up the trust protocol after the first STA indicates to the associated AP about the coex constraints of the second STA.

According to some embodiments, in order for the first STA to set up the trust protocol for the purpose of coex event indication for a second STA, both the first STA and the second STA may need to be associated with the same AP. According to another embodiment, the second STA may not need to be associated with the AP with which the first STA is associated.

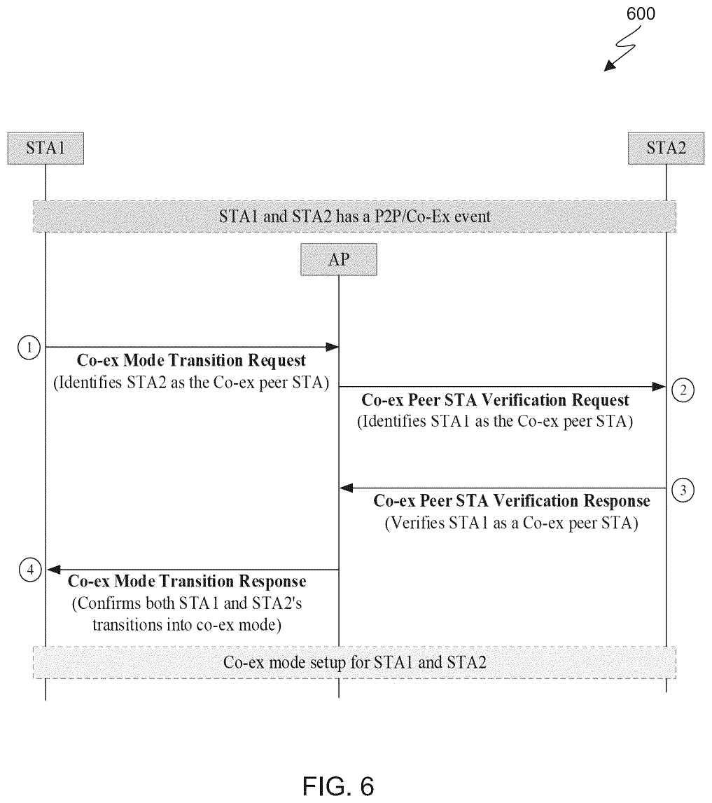

FIG. 6 illustrates an example of a call flow 600 for ensuring trust between peer STAs according to embodiments of the present disclosure. The embodiment of the example of a call flow 600 for ensuring trust between peer STAs shown in FIG. 6 is for illustration only. Other embodiments of the example of a call flow 600 for ensuring trust between peer STAs could be used without departing from the scope of this disclosure.

According to some embodiments, for the scenario where a first STA has a mutual coex event or P2P transmission event scheduled with a second STA, if the first STA intends to inform the associated AP (or a third STA) about the coex event and the corresponding constraints for the second STA, the first STA may send a Coex Mode Transition Request frame to the AP. The Coex Mode Transition Request frame may contain the identifier for the second STA. The second STA may also include other parameters or constraints information of the second STA pertaining to the coex event.

According to one embodiment, upon receiving a Coex Mode Transition Request frame from a first STA that includes identification and other information related to a second STA, the AP (or the third STA) may send a message to the second STA to verify whether the second STA authorizes the first STA for the coex event indication for the second STA. For this purpose, the AP can send a Co-ex peer STA verification Request frame to the second STA.

According to one embodiment, upon reception of the Co-ex Peer STA Verification Request frame from the AP that identifies the first STA as the authorization seeking STA for coex indication on behalf of the second STA, the second STA may send a Co-ex Peer STA Verification Response frame to the AP. The response frame may indicate whether or not the second STA approves the first STA to indicate the second STA's coex event and corresponding constraints to the AP on behalf of the second STA.

According to one embodiment, upon reception of the Co-ex Peer STA Verification Response frame from the second STA, the AP can send a Co-ex Mode Transition Response frame to the first STA. This response frame may—
Confirm the first STA's coex mode transition, but does not confirm the second STA's coex mode transition if the second STA does not approve the first STA to indicate the second STA's coex event and corresponding constraints to the AP on behalf of the second STA.
Confirm the first STA's coex mode transition, and also confirms the second STA's coex mode transition if the second STA approves the first STA to indicate the second STA's coex event and corresponding constraints to the AP on behalf of the second STA.
Does not confirm the coex transition mode for the first STA, and also does not confirm the second STA's coex mode transition if the second STA does not approve the first STA to indicate the second STA's coex event and corresponding constraints to the AP on behalf of the second STA.
Does not confirm the coex transition mode for the first STA, but confirms the confirms the second STA's coex mode transition if the second STA approves the first STA to indicate the second STA's coex event and corresponding constraints to the AP on behalf of the second STA.
   The call flow is illustrated in FIG. 6.

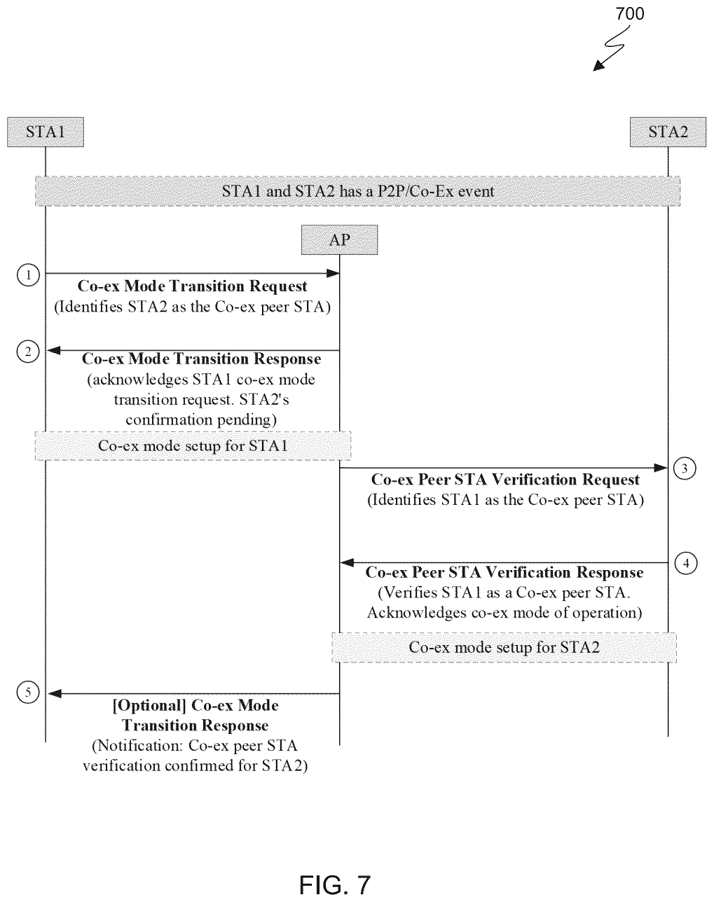

FIG. 7 illustrates an example of another call flow 700 for ensuring trust between peer STAs according to embodiments of the present disclosure. The embodiment of the example of a call flow 700 for ensuring trust between peer STAs shown in FIG. 7 is for illustration only. Other embodiments of the example of a call flow 700 for ensuring trust between peer STAs could be used without departing from the scope of this disclosure.

According to some embodiments, another variation of the call flow illustrated in FIG. 6 can be such that after receiving the coex mode transition request from the first STA that identifies the second STA as the coex peer STA, the AP can first send the response to the first STA, and then send a verification request to the second STA and receive the verification response from the second STA. After successful coex transition request-response exchanges, the STA1's transitioning into the coex mode can be confirmed. After successful verification request-response exchanges, the second STA's transitioning into the coex mode can be confirmed and the first STA's coex indication authority on behalf of the second STA can also be confirmed. Upon receiving the verification response from the second STA, the AP can inform the first STA about whether the second STA's verification has been successful or not. The call flow corresponding to this embodiment is illustrated in FIG. 7.

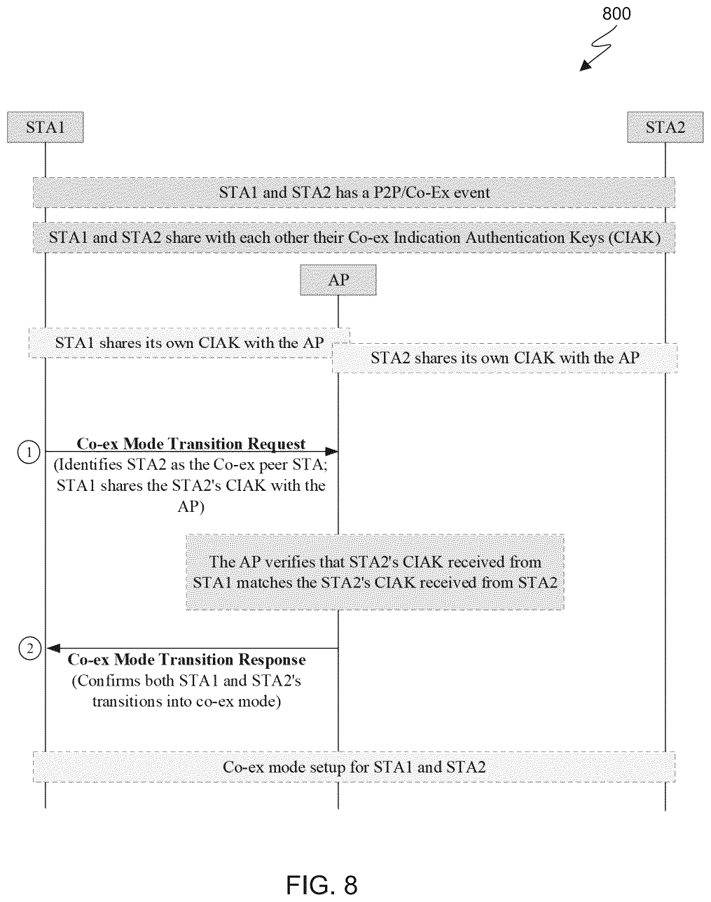

FIG. 8 illustrates yet another example of a call flow 800 for ensuring trust between peer STAs according to embodiments of the present disclosure. The embodiment of the example of a call flow 800 for ensuring trust between peer STAs shown in FIG. 8 is for illustration only. Other embodiments of the example of a call flow 800 for ensuring trust between peer STAs could be used without departing from the scope of this disclosure.

According to some embodiments, for the scenario where a first STA and a second STA have an expected P2P/Co-ex event, the first STA and the second STA can share their exclusive keys with each other. Such keys can be referred to as the Co-ex indication authentication key (CIAK). According to one embodiment the first STA and the second STA may also share their respective CIAK with the associated AP.

According to one embodiment, when the first STA intends to indicate the coex event on behalf of the second STA, the first STA can first send the second STA's CIAK to the AP by including the CIAK in the Co-ex Mode Transition Request frame that identifies the second STA. The AP can then match the second STA's CIAK received from the first STA and the second STA's CIAK received from the second STA. If they match, then the AP can confirm that the first STA is authorized to indicate the coex event on behalf of the second STA. After the authentication, the AP can then respond to the Co-ex Mode Transition Request frame to the first STA by sending a Co-ex Mode Transition Response frame to the first STA. The response frame may indicate whether the first STA's authority to indicate the coex event for the second STA is confirmed or not. The call flow corresponding to this embodiment is shown in FIG. 8.

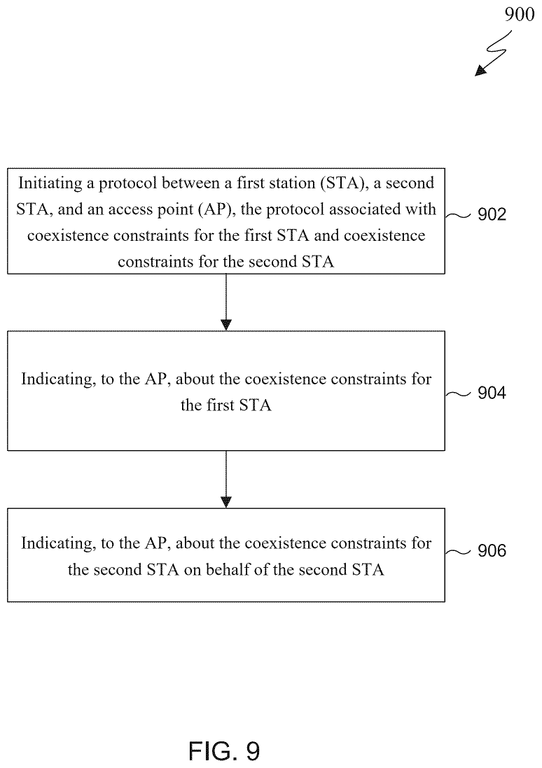

FIG. 9 illustrates an example method 900 performed by a first STA in a wireless communication system according to embodiments of the present disclosure. The method 900 of FIG. 9 can be performed by any of the STAs 111-114 of FIG. 1, such as the STA 111 of FIG. 3, and a corresponding method can be performed by any of the APs 102-103 of FIG. 1, such as AP 102 of FIG. 2. The method 900 is for illustration only and other embodiments can be used without departing from the scope of the present disclosure.

As illustrated in FIG. 9, the method 900 begins at step 902, where a first STA associated with an AP initiates a protocol between the first STA, a second STA, and the AP. The protocol may be associated with coexistence constraints for the first STA and coexistence constraints for the second STA. At step 904, the first STA indicates, to the AP, about the coexistence constraints for the first STA. At step 906, the first STA indicates, to the AP, about the coexistence constraints for the second STA on behalf of the second STA.

In some embodiments, the first STA has a mutual coexistence event scheduled with the second STA; and to initiate the protocol between the first STA, the second STA, and the AP, the first STA transmits a coexistence mode transition request to the AP that identifies the second STA as a coexistence peer STA of the first STA.

In some embodiments, the first STA receives a coexistence mode transition response from the AP, where the coexistence mode transition response: confirms a coexistence mode transition of the first STA, but does not confirm a coexistence mode transition of the second STA if the second STA does not approve the first STA to indicate the coexistence constraints for the second STA on behalf of the second STA; or confirms the coexistence mode transition of the first STA, and also confirms the coexistence mode transition of the second STA if the second STA approves the first STA to indicate the coexistence constraints for the second STA on behalf of the second STA; or does not confirm the coexistence mode transition of the first STA, and also does not confirm the coexistence mode transition of the second STA if the second STA does not approve the first STA to indicate the coexistence constraints for the second STA on behalf of the second STA; or does not confirm the coexistence mode transition of the first STA, but confirm the coexistence mode transition of the second STA if the second STA approves the first STA to indicate the coexistence constraints for the second STA on behalf of the second STA.

In some embodiments, the first STA receives a coexistence mode transition response from the AP, wherein the coexistence mode transition response: acknowledges the coexistence mode transition request; and confirms a coexistence mode transition of the first STA.

In some embodiments, the coexistence mode transition response further: confirms the first STA to indicate the coexistence constraints for the second STA on behalf of the second STA; and confirms a coexistence mode transition of the second STA.

In some embodiments, the first STA has a mutual coexistence event scheduled with the second STA; and the first STA shares a coexistence indication authentication key of the second STA.

In some embodiments, the first STA transmits a coexistence mode transition request to the AP that identifies the second STA as a coexistence peer STA of the first STA, wherein the coexistence mode transition request includes the coexistence indication authentication key of the second STA; and receives a coexistence mode transition response from the AP based on the coexistence indication authentication key of the second STA, wherein the coexistence mode transition response: confirms a coexistence mode transition of the first STA; confirms the first STA to indicate the coexistence constraints for the second STA on behalf of the second STA; and confirms a coexistence mode transition of the second STA.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first station (STA) associated with an access point (AP), the method comprising:
initiating a protocol between the first STA, a second STA, and the AP, the protocol associated with coexistence constraints for the first STA and coexistence constraints for the second STA;
indicating, to the AP, about the coexistence constraints for the first STA; and
indicating, to the AP, about the coexistence constraints for the second STA on behalf of the second STA.

2. The method of claim 1, wherein:
the first STA has a mutual coexistence event scheduled with the second STA; and
initiating the protocol between the first STA, the second STA, and the AP comprises transmitting a coexistence mode transition request to the AP that identifies the second STA as a coexistence peer STA of the first STA.

3. The method of claim 2, further comprising:
receiving a coexistence mode transition response from the AP, wherein the coexistence mode transition response:
confirms a coexistence mode transition of the first STA, but does not confirm a coexistence mode transition of the second STA if the second STA does not approve the first STA to indicate the coexistence constraints for the second STA on behalf of the second STA; or
confirms the coexistence mode transition of the first STA, and also confirms the coexistence mode transition of the second STA if the second STA approves the first STA to indicate the coexistence constraints for the second STA on behalf of the second STA; or
does not confirm the coexistence mode transition of the first STA, and also does not confirm the coexistence mode transition of the second STA if the second STA does not approve the first STA to indicate the coexistence constraints for the second STA on behalf of the second STA; or
does not confirm the coexistence mode transition of the first STA, but confirm the coexistence mode transition of the second STA if the second STA approves the first STA to indicate the coexistence constraints for the second STA on behalf of the second STA.

4. The method of claim 2, further comprising:
receiving a coexistence mode transition response from the AP, wherein the coexistence mode transition response:
acknowledges the coexistence mode transition request; and
confirms a coexistence mode transition of the first STA.

5. The method of claim 4, wherein the coexistence mode transition response further:
confirms the first STA to indicate the coexistence constraints for the second STA on behalf of the second STA; and
confirms a coexistence mode transition of the second STA.

6. The method of claim 1, wherein:
the first STA has a mutual coexistence event scheduled with the second STA; and
the method further comprises sharing a coexistence indication authentication key of the second STA.

7. The method of claim 6, wherein:
initiating the protocol between the first STA, the second STA, and the AP comprises:
transmitting a coexistence mode transition request to the AP that identifies the second STA as a coexistence peer STA of the first STA, wherein the coexistence mode transition request includes the coexistence indication authentication key of the second STA; and
receiving a coexistence mode transition response from the AP based on the coexistence indication authentication key of the second STA, wherein the coexistence mode transition response:
confirms a coexistence mode transition of the first STA;
confirms the first STA to indicate the coexistence constraints for the second STA on behalf of the second STA; and
confirms a coexistence mode transition of the second STA.

8. An access point (AP), comprising:
a processor; and
a transceiver operably coupled with the processor, the transceiver configured to:
receive, from a first station (STA) associated with the AP, information associated with initiating a protocol between the first STA, a second STA, and the AP, the protocol associated with coexistence constraints for the first STA and coexistence constraints for the second STA;
receive an indication from the first STA about the coexistence constraints for the first STA;
receive an indication from the first STA about the coexistence constraints for the second STA on behalf of the second STA; and
transmit, to the first STA, signals associated with the protocol.

9. The AP of claim 8, wherein:
the processor is configured to identify that the first STA has a mutual coexistence event scheduled with the second STA; and
the transceiver is further configured to receive, from the first STA, a coexistence mode transition request that identifies the second STA as a coexistence peer STA of the first STA.

10. The AP of claim 9, wherein:
the transceiver is further configured to transmit a coexistence mode transition response to the first STA; and
the coexistence mode transition response:
confirms a coexistence mode transition of the first STA, but does not confirm a coexistence mode transition of the second STA if the second STA does not approve the first STA to indicate the coexistence constraints for the second STA on behalf of the second STA; or
confirms the coexistence mode transition of the first STA, and also confirms the coexistence mode transition of the second STA if the second STA approves the first STA to indicate the coexistence constraints for the second STA on behalf of the second STA; or
does not confirm the coexistence mode transition of the first STA, and also does not confirm the coexistence mode transition of the second STA if the second STA does not approve the first STA to indicate the coexistence constraints for the second STA on behalf of the second STA; or
does not confirm the coexistence mode transition of the first STA, but confirm the coexistence mode transition of the second STA if the second STA approves the first STA to indicate the coexistence constraints for the second STA on behalf of the second STA.

11. The AP of claim 9, wherein:
the transceiver is further configured to transmit a coexistence mode transition response to the first STA; and
the coexistence mode transition response:
acknowledges the coexistence mode transition request; and
confirms a coexistence mode transition of the first STA.

12. The AP of claim 11, wherein the coexistence mode transition response further:
confirms the first STA to indicate the coexistence constraints for the second STA on behalf of the second STA; and
confirms a coexistence mode transition of the second STA.

13. The AP of claim 8, wherein:
the processor is configured to identify that the first STA has a mutual coexistence event scheduled with the second STA; and
the transceiver is further configured to:
receive a shared coexistence indication authentication key of the second STA;
receive a coexistence mode transition request that identifies the second STA as a coexistence peer STA of the first STA, wherein the coexistence mode transition request includes the coexistence indication authentication key of the second STA; and
transmit, to the first STA, a coexistence mode transition response based on the coexistence indication authentication key of the second STA, wherein the coexistence mode transition response:
confirms a coexistence mode transition of the first STA;
confirms the first STA to indicate the coexistence constraints for the second STA on behalf of the second STA; and
confirms a coexistence mode transition of the second STA.

14. A first station (STA), comprising:
a transceiver; and
a processor operably coupled with the transceiver, the processor configured to:
initiate a protocol between the first STA, a second STA, and an access point (AP) associated with the first STA, the protocol associated with coexistence constraints for the first STA and coexistence constraints for the second STA;
generate an indication about the coexistence constraints for the first STA; and
generate an indication about the coexistence constraints for the second STA on behalf of the second STA.

15. The first STA of claim 14, wherein:
the first STA has a mutual coexistence event scheduled with the second STA; and
to initiate the protocol between the first STA, the second STA, and the AP, the processor is further configured to generate a coexistence mode transition request to the AP that identifies the second STA as a coexistence peer STA of the first STA.

16. The first STA of claim 15, wherein:
the processor is further configured to receive, via the transceiver, a coexistence mode transition response from the AP; and
the coexistence mode transition response:
confirms a coexistence mode transition of the first STA, but does not confirm a coexistence mode transition of the second STA if the second STA does not approve the first STA to indicate the coexistence constraints for the second STA on behalf of the second STA; or
confirms the coexistence mode transition of the first STA, and also confirms the coexistence mode transition of the second STA if the second STA approves the first STA to indicate the coexistence constraints for the second STA on behalf of the second STA; or
does not confirm the coexistence mode transition of the first STA, and also does not confirm the coexistence mode transition of the second STA if the second STA does not approve the first STA to indicate the coexistence constraints for the second STA on behalf of the second STA; or
does not confirm the coexistence mode transition of the first STA, but confirm the coexistence mode transition of the second STA if the second STA approves the first STA to indicate the coexistence constraints for the second STA on behalf of the second STA.

17. The first STA of claim 15, wherein:
the processor is further configured to receive, via the transceiver, a coexistence mode transition response from the AP; and
the coexistence mode transition response:
acknowledges the coexistence mode transition request; and
confirms a coexistence mode transition of the first STA.

18. The first STA of claim 17, wherein the coexistence mode transition response further:
confirms the first STA to indicate the coexistence constraints for the second STA on behalf of the second STA; and
confirms a coexistence mode transition of the second STA.

19. The first STA of claim 14, wherein:
the first STA has a mutual coexistence event scheduled with the second STA; and
the processor is further configured, via the transceiver, to share a coexistence indication authentication key of the second STA.

20. The first STA of claim 19, wherein to initiate the protocol between the first STA, the second STA, and the AP, the processor is further configured to:
transmit, via the transceiver, a coexistence mode transition request to the AP that identifies the second STA as a coexistence peer STA of the first STA, wherein the coexistence mode transition request includes the coexistence indication authentication key of the second STA; and
receive, via the transceiver, a coexistence mode transition response from the AP based on the coexistence indication authentication key of the second STA, wherein the coexistence mode transition response:
confirms a coexistence mode transition of the first STA;
confirms the first STA to indicate the coexistence constraints for the second STA on behalf of the second STA; and
confirms a coexistence mode transition of the second STA.
